(19) United States
(12) Patent Application Publication
(10) Pub. No.: US 2024/0424332 A1
(43) Pub. Date: Dec. 26, 2024

(54) METHOD FOR SUPPRESSION OF BATTERY HAZARDS

(71) Applicant: Tyco Fire Products LP, Cranston, RI (US)

(72) Inventors: Ben Markovitz, Howard, WI (US); Blake H. Bomann, Greenville, WI (US)

(73) Assignee: Tyco Fire Products LP, Cranston, RI (US)

(21) Appl. No.: 18/655,019

(22) Filed: May 3, 2024

Related U.S. Application Data
(60) Provisional application No. 63/522,086, filed on Jun. 20, 2023.

(51) Int. Cl. A62D 1/00

(52) U.S. Cl. CPC A62D 1/0042

(57) ABSTRACT

A method of extinguishing or abating a lithium battery fire includes administering to the lithium battery fire a firefighting composition including a surfactant component including one or more non-ionic surfactants; a polysaccharide component; and water.

### CROSS REFERENCE TO RELATED APPLICATIONS

This application claims the benefit of priority to U.S. Provisional Patent Application No. 63/522,086 filed Jun. 20, 2023, which is hereby incorporated by reference, in its entirety for any and all purposes.

### TECHNOLOGY

The present technology is generally related to firefighting compositions and methods of extinguishing or abating a battery fire. Specifically, the technology is related to firefighting compositions including a surfactant component including one or more non-ionic surfactants; a polysaccharide component; and a diluent for extinguishing or abating battery (e.g., lithium battery) fires.

### SUMMARY OF THE INVENTION

In an aspect, a method of extinguishing or abating a lithium battery fire includes: administering to the lithium battery fire a fire-fighting composition including: a surfactant component including one or more non-ionic surfactants; a polysaccharide component; and water.

In some embodiments, the fire-fighting composition includes: about 0.1 to 25 wt % of the surfactant component; about 0 to 1.5 wt % of the polysaccharide component; and at least about 50 wt % of water.

In some embodiments, the fire-fighting composition is salt-free.

In some embodiments, the water is deionized water.

In some embodiments, the surfactant component includes a gemini surfactant, an alcohol-based surfactant, a sugar-based surfactant, a silicone surfactant, a defoaming agent, a fatty acid, a fatty ester, or a combination of any two or more thereof.

In some embodiments, the alcohol-based surfactant includes an aliphatic alcohol-based surfactant, an ethoxylated alcohol, a propoxylated alcohol, a guerbet alcohol, or a combination of any two or more thereof.

In some embodiments, the aliphatic alcohol-based nonionic surfactant includes a C8-C14 aliphatic alcohol or a C10-C16 aliphatic alcohol ethoxylate.

In some embodiments, the aliphatic alcohol-based nonionic surfactant includes octyl alcohol, decyl alcohol, lauryl alcohol, myristyl alcohol, or a combination of any two or more thereof.

In some embodiments, the sugar-based surfactant includes an alkyl glycoside or an alkyl polyglycoside (APG).

In some embodiments, the alkyl glycoside or alkyl polyglycoside (APG) each include a C8-C16 alkyl.

In some embodiments, the sugar-based surfactant includes octyl glucoside, decyl glucoside, lauryl glucoside, decyl maltoside, dodecyl maltoside, or an alkyl polyglucoside.

In some embodiments, the polysaccharide component includes agar, sodium alginate, carrageenan, gum arabic, gum guaicum, neem gum, Pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, succinoglycan, mastic gum, spruce gum, tara gum, gellan gum, xanthan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or a mixture of any two or more thereof.

In some embodiments, the fire-fighting composition further includes an additive component including at least one of an organic solvent, a corrosion inhibitor, a biocide, a dye, or a reducing agent.

In some embodiments, the fire-fighting composition includes 0 to 0.5 wt. % of the additive component.

In some embodiments, the additive component is salt-free.

In some embodiments, the organic solvent includes a glycol or an alkyl alcohol.

In some embodiments, the glycol includes butyl glycol, propylene glycol, or hexylene glycol.

In some embodiments, the lithium battery fire is outdoors, in a building, or in an electric vehicle.

In an aspect, a method of controlling a thermal runaway event associated with a lithium battery includes: administering to the lithium battery a fire-fighting composition including: a surfactant component including one or more non-ionic surfactants; a polysaccharide component; and water.

In an aspect, a method of extinguishing or abating a lithium battery fire includes: administering to the lithium battery fire a fire-fighting composition including: a surfactant component including one or more non-ionic surfactants; a polysaccharide component; and a diluent.

In some embodiments, the fire-fighting composition includes: about 0.1 to 25 wt % of the surfactant component; about 0 to 1.5 wt % of the polysaccharide component; and at least about 50 wt % of diluent.

In some embodiments, the diluent is water.

In some embodiments, the diluent is deionized water.

In some embodiments, the fire-fighting composition further includes an additive component including an organic solvent, a corrosion inhibitor, a biocide, a dye, a reducing agent, or a mixture of two or more thereof.

In an aspect, a method of extinguishing or abating a lithium battery fire includes: administering to the lithium battery fire a fire-fighting composition consisting essentially of: a surfactant component including one or more non-ionic surfactants; a polysaccharide component; an additive component including an organic solvent, a corrosion inhibitor, a biocide, a dye, a reducing agent, or a mixture of two or more thereof; and a diluent.

In some embodiments, the fire-fighting composition consists essentially of: about 0.1 to 25 wt % of the surfactant component; about 0 to 1.5 wt % of the polysaccharide component; about 0 to 0.5 wt. % of the additive component; and at least about 50 wt % of diluent.

In some embodiments, the diluent is water.

In some embodiments, the diluent is deionized water.

### DETAILED DESCRIPTION

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “and” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or illustrative language (e.g., “such as”) provided herein, is intended merely to better illuminate the embodiments and does not pose a limitation on the scope of the claims unless otherwise stated. No language in the specification should be construed as indicating any non-claimed element as essential.

Provided herein are firefighting compositions and methods for fighting battery fires using the firefighting compositions. In some embodiments, the firefighting compositions include a surfactant component comprising one or more non-ionic surfactants; a polysaccharide component; and water. The firefighting compositions described herein are substantially free from salts. In some embodiments, the firefighting compositions are completely free of salts. Without wishing to limit the present disclosure to any theory or mechanism, a completely non-ionic firefighting composition reduces the potential for short circuiting the battery when extinguishing or abating the battery fire, thereby improving safety to both humans and assets. The nonionic surfactants in the firefighting composition help facilitate interaction and cooling effects of the water with the battery and related components.

In one aspect, a method of extinguishing or abating a battery fire is provided. In some embodiments, the method includes administering to the battery fire a fire-fighting composition comprising: a surfactant component comprising one or more non-ionic surfactants; a polysaccharide component; and water. In some embodiments, the firefighting composition comprises from about 0.1 to about 25 wt % of the surfactant component; from about 0 to about 1.5 wt % of the polysaccharide component; and at least about 50 wt % of water.

The methods herein can provide control of a thermal runaway event associated with a lithium battery. The method includes administering to the lithium battery fire a fire-fighting composition a surfactant component that includes one or more non-ionic surfactants; a polysaccharide component; and a diluent.

Provided is a method of extinguishing or abating a battery fire, the method including: administering to the battery fire a fire-fighting composition comprising: a surfactant component comprising one or more non-ionic surfactants; a polysaccharide component; and a diluent.

The firefighting composition, in some embodiments, may contain from about 0.1 to about 25 wt % of the surfactant component; from about 0 to about 1.5 wt % of the polysaccharide component; and at least about 50 wt % of a diluent.

In another aspect, provided is a method of extinguishing or abating a battery fire, the method including: administering to the battery fire a fire-fighting composition consisting essentially of: a surfactant component comprising one or more non-ionic surfactants; a polysaccharide component; an additive component comprising an organic solvent, a corrosion inhibitor, a biocide, a dye, a reducing agent, or a mixture of two or more thereof; and a diluent.

In some embodiments, the firefighting composition may consist essentially of from about 0.1 to about 25 wt % of the surfactant component; from about 0 to about 1.5 wt % of the polysaccharide component; from about 0 to 0.5 wt % of the additive component; and at least about 50 wt % of a diluent.

In some embodiments, the firefighting composition is salt-free. In some embodiments, the firefighting composition comprises less than 1 ppm salt.

In some embodiments, the surfactant component comprises a gemini surfactant, an alcohol-based surfactant, a sugar-based surfactant, a silicone surfactant, a defoaming agent, a fatty acid, a fatty ester, or a combination of any two or more thereof.

In some embodiments, the alcohol-based surfactant comprises an aliphatic alcohol-based surfactant, an ethoxylated alcohol, a propoxylated alcohol, a guerbet alcohol (a β-branched primary alcohol), or a combination of any two or more thereof.

In some embodiments, the nonionic surfactant includes an aliphatic alcohol and/or an aliphatic alcohol ethoxylate. As a non-limiting example, the firefighting composition may include an aliphatic alcohol-based nonionic surfactant including an aliphatic alcohol having 8 to 14 carbon atoms and/or an aliphatic alcohol ethoxylate having 10 to 16 carbon atoms in its alcohol portion. The aliphatic alcohol ethoxylate may have an average degree of polymerization (i.e., the average number of ethylene oxide units) of about 0.7-2.0 and often of no more than about 1.5, no more than about 1.2, or no more than about 1.0. Aliphatic alcohols, which include a linear C₈₋₁₄-aliphatic alcohol, such as a C₈₋₁₄-fatty alcohol, may be used as a nonionic surfactant in the present firefighting compositions. Non-limiting examples of such alcohols include one or more of octyl alcohol, decyl alcohol, lauryl alcohol and myristyl alcohol. The firefighting composition may include an aliphatic alcohol ethoxylate having an average of no more than about 2 ethylene oxide units. In some embodiments, the aliphatic alcohol portion of such ethoxylates has about 10 to 16 carbon atoms. Non-limiting examples include decyl alcohol ethoxylates, lauryl alcohol ethoxylates and/or myristyl alcohol ethoxylates. In some embodiments, the alcohol ethoxylates have an average of no more than about 2 ethylene oxide units, no more than about 1.5 ethylene oxide units, no more than about 1.2 ethylene oxide units and, in some instances, no more than about 1 ethylene oxide units. In some embodiments, the aliphatic alcohol ethoxylate comprises an ethoxylate of a linear C₈₋₁₄-aliphatic alcohol having no more than about 1.2 ethylene oxide units.

In some embodiments, the sugar-based surfactant comprises an alkyl glycoside or an alkyl polyglycoside (APG). In some embodiments, the alkyl glycoside or alkyl polyglycoside (APG) each comprise a C₈-C₁₆ alkyl. In some embodiments, the sugar-based surfactant comprises octyl glucoside, decyl glucoside, lauryl glucoside, decyl maltoside, dodecyl maltoside, or an alkyl polyglucoside.

In some embodiments, the firefighting composition comprises from about 0.1 to 25 wt % of the surfactant component. In some embodiments, the firefighting composition comprises about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, or about 25 wt % of the surfactant component.

In some embodiments, the polysaccharide component comprises agar, sodium alginate, carrageenan, gum arabic, gum guaicum, neem gum, Pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, succinoglycan, mastic gum, spruce gum, tara gum, gellan gum, xanthan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or a mixture of any two or more thereof.

In some embodiments, the firefighting composition comprises from about 0 to 1.5 wt % of the polysaccharide component. In some embodiments, the firefighting composition comprises about 0 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, or about 1.5 wt % of the polysaccharide component.

In some embodiments, the firefighting composition comprises an additive component comprising at least one of an organic solvent, a corrosion inhibitor, a biocide, or a reducing agent. In some embodiments, the additive component is salt-free.

In some embodiments, the organic solvent comprises a glycol, a glycol ether, glycerol, a water-soluble polyethylene glycol, an alkyl alcohol, or a combination of two or more thereof. Examples of organic solvents include, but are not limited to, diethylene glycol n-butyl ether, dipropylene glycol n-propyl ether, hexylene glycol, ethylene glycol, propylene glycol, diethylene glycol, dipropylene glycol, tripropylene glycol, dipropylene glycol monobutyl ether, dipropylene glycol monomethyl ether, diethylene glycol monobutyl ether (“butyl carbitol”), ethylene glycol monobutyl ether, tripropylene glycol monomethyl ether, dipropylene glycol monoethyl ether, glycerol, or a mixtures of two or more thereof. In some embodiments, the organic solvent includes a mixture of an alkylene glycol and a glycol ether, such as a glycol butyl ether. In some embodiments, the organic solvent includes an alkylene glycol ether, such as ethylene glycol monoalkyl ether, propylene glycol monoalkyl ether, dipropylene glycol monoalkyl ether, diethylene glycol monoalkyl ether (e.g., butyl carbitol), or a combination of two or more thereof. In some embodiments, the organic solvent includes an alkylene glycol, such as ethylene glycol, propylene glycol, dipropylene glycol and/or diethylene glycol. In some embodiments, the organic solvent may include a mixture of butyl carbitol and a glycol ether, such as ethylene glycol and/or propylene glycol. As a non-limiting example, the organic solvent may include ethylene glycol and butyl carbitol. In some embodiments, the organic solvent includes propylene glycol and butyl carbitol.

In some embodiments, the corrosion inhibitor includes ortho-phenylphenol, tolyltriazole, and phosphate ester acids. In some embodiments, the corrosion inhibitor is tolyltriazole.

In some embodiments, the biocide includes Kathon CG/ICP (Rohm & Haas Company), Givgard G-4 40 (Givaudan, Inc.), Dowicil 75, or Dowacide A (Dow Chemical Company).

In some embodiments, the reducing agent may be selected such that it is more readily oxidized compared to other components of the firefighting composition. As a non-limiting example, the reducing agent may be oxidized more readily than the sugar component or polysaccharide components. Illustrative reducing agents include, but are not limited to, sodium sulfite, sodium bisulfite, sodium metabisulfite, or a mixture of any two or more thereof.

In some embodiments, the firefighting composition comprises from about 0 to about 0.5 wt % of the additive component. In some embodiments, the firefighting composition comprises about 0 wt %, about 0.1 wt %, about 0.2 wt %, about 0.3 wt %, about 0.4 wt %, or about 0.5 wt % of the additive component.

In some embodiments, the water is deionized water. In some embodiments, the firefighting composition comprises at least about 50 wt % of water. In some embodiments, the firefighting composition comprises 50 wt % water, 55 wt % water, 60 wt % water, 65 wt % water, 70 wt % water, 75 wt % water, 80 wt % water, 85 wt % water, 90 wt % water, or 95 wt % water.

In some embodiments, the diluent is water. In some embodiments, the diluent is deionized water. In some embodiments, the firefighting composition comprises at least about 50 wt % of diluent. In some embodiments, the firefighting composition comprises 50 wt % diluent, 55 wt % diluent, 60 wt % diluent, 65 wt % diluent, 70 wt % diluent, 75 wt % diluent, 80 wt % diluent, 85 wt % diluent, 90 wt % diluent, or 95 wt % diluent.

In some embodiments, the battery is a lithium battery. In some embodiments, the battery fire is a lithium battery fire. In some embodiments, the lithium battery fire is outdoors, in a building, or in an electric vehicle.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method of extinguishing or abating a lithium battery fire, the method comprising:
administering to the lithium battery fire a fire-fighting composition comprising:
a surfactant component comprising one or more non-ionic surfactants;
a polysaccharide component; and
water.

2. The method of claim 1, wherein the fire-fighting composition comprises:
about 0.1 to 25 wt % of the surfactant component;
about 0 to 1.5 wt % of the polysaccharide component; and
at least about 50 wt % of water.

3. The method of claim 1, wherein the fire-fighting composition is salt-free.

4. The method of claim 1, wherein the water is deionized water.

5. The method of claim 1, wherein the surfactant component comprises a gemini surfactant, an alcohol-based surfactant, a sugar-based surfactant, a silicone surfactant, a defoaming agent, a fatty acid, a fatty ester, or a combination of any two or more thereof.

6. The method of claim 5, wherein the alcohol-based surfactant comprises an aliphatic alcohol-based surfactant, an ethoxylated alcohol, a propoxylated alcohol, a guerbet alcohol, or a combination of any two or more thereof.

7. The method of claim 5, wherein the sugar-based surfactant comprises an alkyl glycoside or an alkyl polyglycoside (APG).

8. The method of claim 7, wherein the sugar-based surfactant comprises octyl glucoside, decyl glucoside, lauryl glucoside, decyl maltoside, dodecyl maltoside, or an alkyl polyglucoside.

9. The method of claim 1, wherein the polysaccharide component comprises agar, sodium alginate, carrageenan, gum arabic, gum guaicum, neem gum, Pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, succinoglycan, mastic gum, spruce gum, tara gum, gellan gum, xanthan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or a mixture of any two or more thereof.

10. The method of claim 1, wherein the fire-fighting composition further comprises an additive component comprising at least one of an organic solvent, a corrosion inhibitor, a biocide, a dye, or a reducing agent.

11. The method of claim 10, wherein the fire-fighting composition comprises 0 to 0.5 wt. % of the additive component.

12. The method of claim 10, wherein the additive component is salt-free.

13. The method of claim 10, wherein the organic solvent comprises a glycol or an alkyl alcohol.

14. The method of claim 13, wherein the glycol comprises butyl glycol, propylene glycol, or hexylene glycol.

15. The method of claim 1, wherein the lithium battery fire is outdoors, in a building, or in an electric vehicle.

16. A method of controlling a thermal runaway event associated with a lithium battery, the method comprising:
administering to the lithium battery fire a fire-fighting composition comprising:
a surfactant component comprising one or more non-ionic surfactants;
a polysaccharide component; and
water.

17. A method of extinguishing or abating a lithium battery fire, the method comprising:
administering to the lithium battery fire a fire-fighting composition comprising:
a surfactant component comprising one or more non-ionic surfactants;
a polysaccharide component; and
a diluent.

18. The method of claim 17, wherein the fire-fighting composition comprises:
about 0.1 to 25 wt % of the surfactant component;
about 0 to 1.5 wt % of the polysaccharide component; and
at least about 50 wt % of diluent.

19. The method of claim 17, wherein the diluent is deionized water.

20. The method of claim 17, wherein the fire-fighting composition further comprises an additive component comprising an organic solvent, a corrosion inhibitor, a biocide, a dye, a reducing agent, or a mixture of two or more thereof.
